(19) United States
(12) Patent Application Publication
(10) Pub. No.: US 2010/0259361 A1
(43) Pub. Date: Oct. 14, 2010

(54) SECURITY GATES DEVICE

(76) Inventor: Hmoud Sayaf AL SHAHRANI, Khamis Mushait (SA)

Correspondence Address: SUGHRUE MION, PLLC, 2100 PENNSYLVANIA AVENUE, N.W., SUITE 800, WASHINGTON, DC, 20037, US

(21) Appl. No.: 12/757,629

(22) Filed: Apr. 9, 2010

(30) Foreign Application Priority Data
Apr. 11, 2009 (SA) 109300217

(51) Int. Cl. G08B 29/00

(52) U.S. Cl. 340/5.71

(57) ABSTRACT

The security gate device is the one that has the ability to deter and seize unauthorized vehicles to enter and that attempt to envade the place; this can be done automatically without giving human being orders. The device is equipped with a room consisting of bumpers and anti-blast walls to protect the facility and the workers from damage caused by such an explosion. Meanwhile, this device can arrest the intruders of the gate.

### INVENTION BACKGROUND

In the present condition of the security gates, there is no technical security method that avoids the power of the blast and the direction of the blast fragments to protect the facility and the workers from the damage of the explosion. Additionally, in case of the loss of the gate worker for whatever circumstances, the attacker will pass by the gate peacefully into the facility. It is noted in the current security gates that there is a concentration in the concrete works that caused traffic problems and have disadvantages for those who are authorized to enter the facility as well as visitors. When a vehicle is impounding the gate, there is the problem of resisting and arresting the persons and weapons might be used. Also, if the vehicle is sopped through the present bumpers available, the vehicle and the persons will be exposed to serious injuries due to the sudden stoppage besides the attacker can retreat and escape.

### GENERAL DESCRIPTION OF THE INVENTION

The current invention is characterized that it protects the guards and the facility from the blast damages with guards help. Individuals and the vehicles of all types cannot pass by the gate in an irregular method as the device will impound the vehicle attempting to escape or retreat if the attack fails. Additionally, it prevents the unauthorized vehicles from entering through their weights and identifies the vehicle weight upon entering and when they exit after being loaded with the materials. One of the features of the device is that it can be used as explosives detector as well as weapons detector programmed with a device for a comprehensive security protection.

Individuals are arrested without the use of a military troop and the use of arms, where the one who climbs the gate to assault is arrested without much effort when turning on the comprehensive security protection. The device is also considered to be effective in its performance in carrying out its security duties without causing injuries to the attackers or the guards. The device is also characterized for being able to stop the precipitous vehicle and to absorb its speed then make it stop to avoid injuries as a result of the sudden stop as the device is equipped with speed bump to reduce speed while passing over it at the same time it is used to absorb speed of the precipitous vehicle in case it tries to intrude.

Other feature of the security gates device is that it is invisible and no one can notice that it exists at the gate. Its size is small and can hold large vehicles through its front tunnel. While the device is operating, it can produce a vehicle lights toward the intruder. Also, the device has the ability to deter the second and third intrusion supporting the first intrusion automatically. It directly operates the warning alarm and a camera to record the actions that the can be utilized in investigation. It operates through programming the comprehensive security protection and reduces the number of guards at end of the working hours or when the sun sets as needed. The device can be equipped with a system of remote control, fingerprint, or PIN used by the guards so that no one can use it. The device can arrest the intruders without losses in human lives. Also, it is equipped with an electronic card system as well as a system to count vehicles entering the gate with the ability to identify their types, number and the date. It allows the employee vehicles to get in through the gate automatically to avoid any traffic congestion.

### BRIEF DESCRIPTION OF FIGURES

FIG. 1: a top image of the protection device in standby status showing the details of the device.

FIG. 2: a side image of the protection device showing an authorized vehicle passing through, and the explosion bumpers turned off to allow the vehicle get into the facility peacefully.

FIG. 3: a side image of explosion bumpers room explaining the rising up of the bumpers in front of the vehicle so at to absorb the speed of the vehicle and to stop it accordingly.

FIG. 4: a side image of explosion bumpers room showing the rising up of the back side of the vehicle to force it to get into the room.

FIG. 5: a side image of explosion bumpers room showing the vehicle getting into the room completely.

FIG. 6: a side image of explosion bumpers room showing the tunnel in the front to accommodate the large vehicles.

FIG. 7: a front image of explosion bumpers room showing the authorized vehicles passing by the gate peacefully and the room is turned off to allow the vehicle to get in peacefully.

FIG. 8: a front image of explosion bumpers room showing the vehicle getting into the room describing the high of the side cages which arrest the individuals.

FIG. 9: a front image describing the main gate of the facility and describes the sensors positions located in front of the gates as well as it describes the weighing machine and the bunker.

FIG. 10: a top image of explosion bumpers room showing how the roof of the room is concealed.

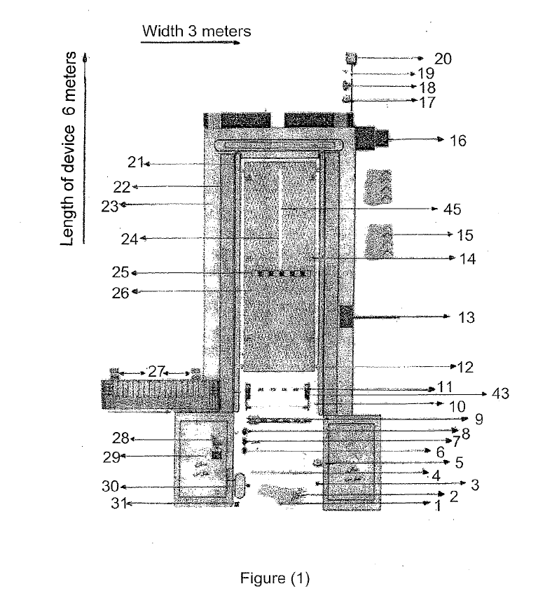

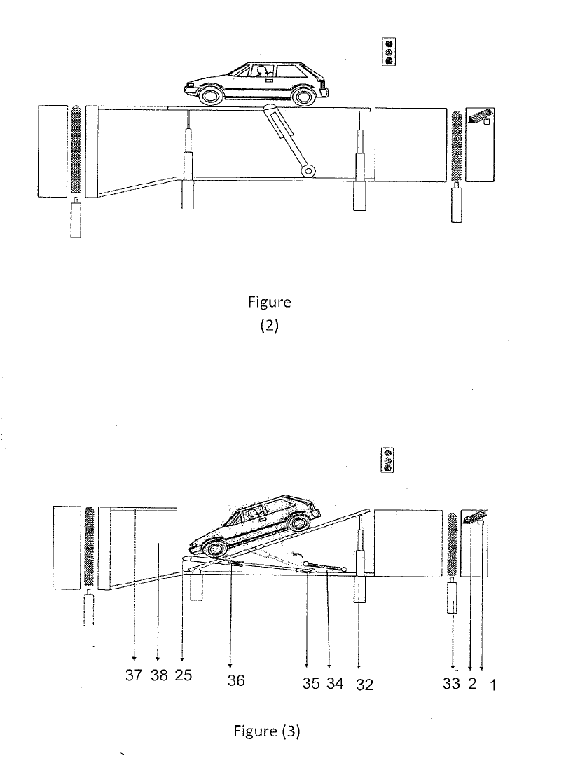

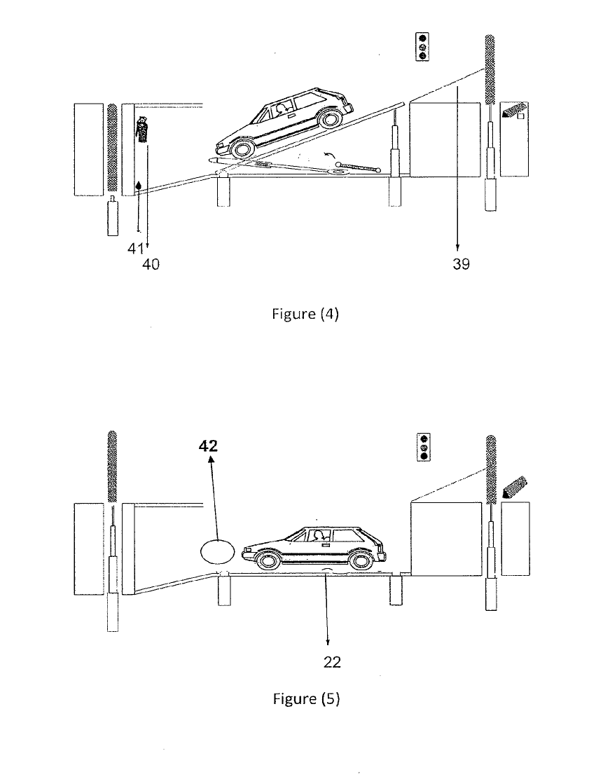

### DETAILED DESCRIPTION

When any vehicle enters the gate, a special device operates with metal parts (31) to identify the vehicles if they are authorized or not. If the vehicle is authorized to enter, it passes safely and during this stage the sensor will be in green color (10) which allows the vehicle to pass through peacefully. If the vehicle is unauthorized, then the sensor signal (10) will stay in red color which means that the vehicle must stop to be inspected by the security guards. While inspecting the vehicle, the explosives detector (7) and the arms detector (7) in addition to a detector equipped with a camera and a screen (6) will operate. These devices are directed by the security guard in the special room using the screen for this purpose. The sensitive device (10) is connected with an entering signal which so they work together simultaneously. When the authorized vehicle enters, it passes over the surface of the device (26) that equals to the ground surface and the vehicle also passes through an artificial low speed plumb (25) that allow the vehicle to pass and to oblige the vehicle to abide by the speed limit.

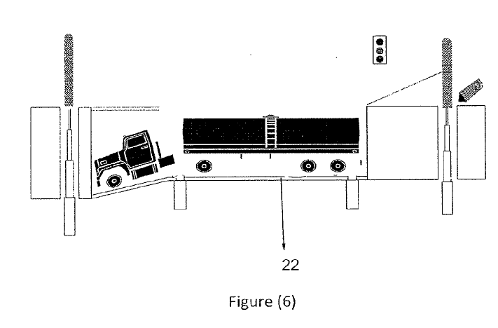

In case the unauthorized vehicle enters and tries to intrude the gate and trespass the red light (43), the security system will operate. As when the vehicle intrudes the gate and passes through the ray (10) and the ground pad (11) and when the security system operates, it works through stages. Firstly, the four are released and the bump starts to rise up (25) to turn into a source of absorbing the vehicle speed, and absorption method is through pushing the bumper forward within the track (24), during this the surfaces of the device (26) is forced to go down from the front side and is balanced by a rubber spring (44) to protect the vehicle to collide with the room floor. The speed bump operates (25) and rising up by air pistons and spring (36). The track (24) includes a sensor (45) in its center as when the bump moves upon it, the sensor gives a signal that the vehicle in the middle of the device surface responds to the hydraulic pump responds so as to operate all the air pistons of which the piston (32) which pushes down the device surface from backside and pushing up the side frames (21) to hook up the intruders and prevent them from running away from the vehicle on their feet. In addition, the backstop (2) on the entry of the gate rises to deter any additional intrusion on the gate. Moreover, a frame rises in the front side (4) to arrest the intruders and deter any walking persons. Moreover, one of the devices that are operating during intrusion is the alarm bell for workers (5), a warning bell within the facility (17) a security vibratory (18), and a security camera (19) to record the events of the intrusion and transfer them to the monitoring screens and a loopy lighting (20) that is directed towards the intruder so as not to see what is behind the lighting. Also, when the device operates and the vehicle enters inside the room, the main gate will be closed (27). In so doing, the intruding vehicle will be inside the room as in FIG. 5 trapped inside the walls of the room provided by the bombing fender (22).

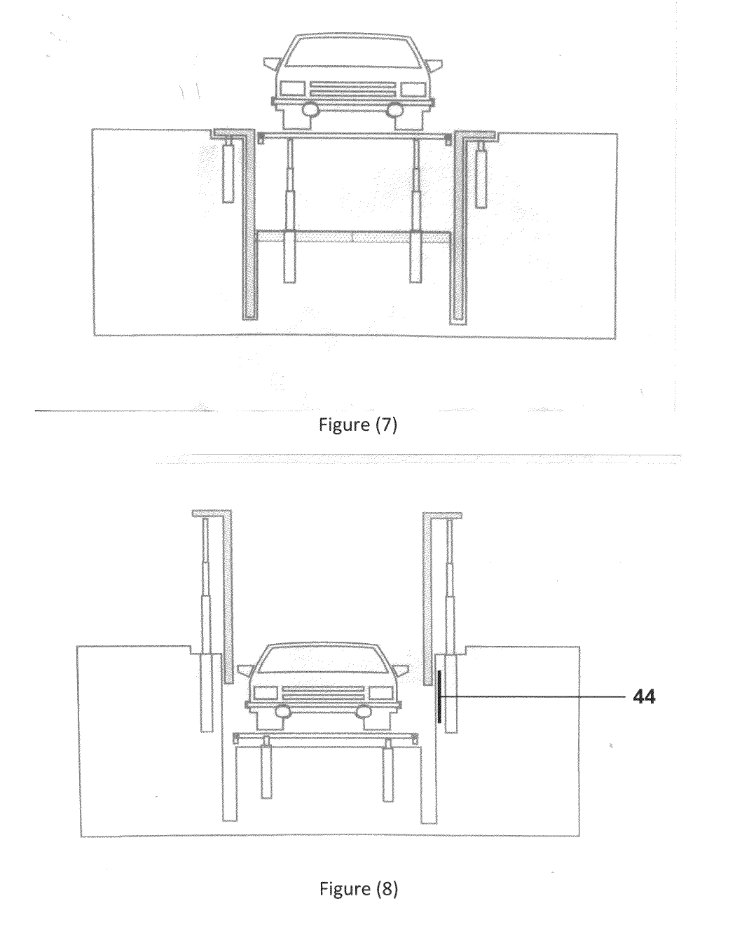

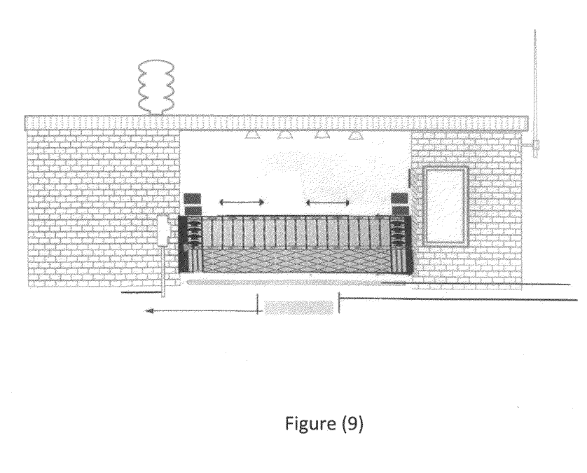

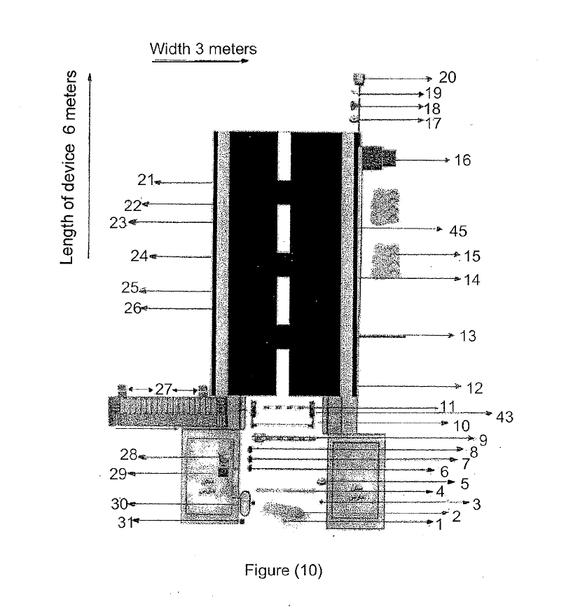

The room can be expanded and to be provided with a front tunnel (37), (38), to accommodate trucks and large vehicles, as shown in FIG. 6). When the intruding vehicle is stopped by the roof of the device (26) and it tries to go back to escape the fender (4), it rises from the rear side of the vehicle lifts it from behind by wire (39) to force the vehicle to advance and go into the fender room.

When the intruding vehicle blasts inside the room, it shall be trapped inside the room by the fenders (22) that force the blast to go up where the concrete ingots are available around the security device (15) to prevent the spread of fragments from spreading, also these ingots (15) force the vehicles to pass over the surface of the security device (26). One of the features of the surface of the device is that tit concealed (26) and no one feels its presence in the gate, as shown in FIG. 10).

When the intruders climber the main gate (27), the sensors of the gate operates to give a signal to the nets (21) from all the four sides to arrest the persons inside them and operating the apparatuses 17.5, 18, 19,20. The device can be connected with solar cells (16) so that the security gate is closed in the evening by pushing the surface of the device (26) from the front side and remove the studs (12) and pushing up the frontal bumper (2), and also raise bumper (25) and also solar-powered cat eyes (14) are placed on the surface of the security device (26).

The security device can be fully linked with a remote control and the signals can be received through a receiver (13). Before the vehicle enters to pass the security gate it passes by a sensor (3) to prevent entry duplication of several vehicles simultaneously. The bottom of the fender (2) can be equipped with an electronic device (1) for weight so as to weight of vehicles entering the gate and also to determine the weight of the vehicle when it leaves the facility after loading it with the materials, as well as to prevent the entry of the violating vehicles, whether trucks or cars.

### A Ground Gates Security Device

1—When the intrusion vehicle is stopped, this is done though two stages:
   a. It absorbs the vehicle speed within several meters.
   b. It fully stops the vehicle so as to avoid any injuries as a result f the sudden stop.
2—It will not be allowed for any vehicle to enter when it intrudes the gate so the vehicle is detained whether it is a heavy or light transportation vehicle, even if it is 4×4 as well as the passengers whatever their total. Any person violate the system cannot retreat or flee as well as he will not be able to proceed in entering and passing by the gates.
3—It detains the persons who get out of the vehicle when it is detained by the device and want to walk whatever their total.
4—Detaining the vehicles and persons violating the system at the gate as it is equipped with a ready system to deter any additional assault after the previous assault. It also ready to deter the second, third, and fourth intrusion supporting the first intrusion. Nevertheless, it detains the first intruder in the same time.
5—It gives a command to turn on the alarm system inside the facility for the workers or the person who is in charge of the facility. It should be having a distinguished for all to support the official gate as well as being alert.
6—It gives a command of turning on buttons of strong lighting. These buttons do not operate except by the command of the device as the previous basic lighting can be destroyed at the gate and on the way to the facility. Thus, new lightings can be destroyed and on the way to the facility as the new lightings work and the reason is that:
   a. The intruder does not exploit the dark nights.
   b. To introduce conducing curvy lightings so that the intruder cannot see what is behind the lighting
   c. The imaging for cameras shall be clearer and accurate in determining the description of the one who violates the rules.
7—An order is given to the video camera to record all the action (sound and image) just to help in identification of the action.
8—The command is given to run cameras installed at the gate and on the way leading to the facility to for a live streaming on a large screen inside the facility available at the employee in charge or the other employees.
9—An alarm is given to those at the main gate the device has been turned on just to allow it to operate or to turn it off using a PIN code or programmed imprinting.
10—Equipped with an efficient and ready system, with God Help, to deter and repression of any vehicle intrudes the gate with the intention to pass the gate to be exploded inside as it provides the following:
   a. When the vehicle exploded inside the device, the device itself controls the blast strength and the direction of fragments.
   b. Weakening, constrain, and absorb the explosion.
   c. Controlling the direction of the fragments and the explosion so that the employees are safe from being injured and the like. Also, the facility surrounding the site is safe. Taking in consideration that the system operates automatically in less than one second without giving any human command
11—Equipped with weapons detector operates automatically along with the device and according to the gate requirements
12—Equipped with explosives detector that operates automatically along with the device or any other detection device according to the gate requirements.
13—Certain gates operate automatically without human commands at sunset or by the end of the working hours at the facility. This is can be achieved by closing the gate as well as the road and being prepared to detain individuals who climb the gate whatever their number. In case that any one tries to intrude, then the device will operate, and at sunrise the device retunes to carry out its functions assigned to it this device indicates that there is not any need for the manpower by the end of the working hours and can be directed to carry out other duties or to lay them off completely.
14—Equipped with a remote control which facilitates the movement of the guard during the inspection of the vehicles at the gate and which executes the commands of the guard soon and remotely as follows:
   a. Closing the gate . . . Opening the gate.
   b. Closing the road . . . opening the road.
   c. Detaining the vehicle . . . releasing the vehicle.
   d. Detaining individuals at the gate . . . releasing individuals at the gate.
   e. Turning off the lights . . . turning on the lights.
   f. Turning on the alarm bell . . . turning off the alarm bell.
   g. Detaining individuals trying to climb the gate . . . releasing them.
15—The traffic signs shall be used at the gate of the trucks as need and as follows:

| | |
|---|---|
| Truck/Entry is Prohibited/ | Cars/Entry is Prohibited/ |
| Allowed | Allowed |

The device is equipped with a system that deters and suppresses anyone who violates the guiding sign at the gate automatically without giving any human commands.
Reasons for having this system with the device!!!!!! That is because trucks are stronger and more in pushing up while intruding. This system breaks such strength.
16—The reasons behind using the imprinting system or the PIN code among the employees and the device as to be an obstacle before the intruder in case any incident happens to the gaud at the gate. This means that the intruder will not be able to open the gate easily so as not to pass the device safely.
17—The device is equipped with a system that operates against the intruder who walks without using any vehicles and tries to climb the main gate. Then the device starts working as they try to intrude the facility.
18—Equipped with a system that terminates the role of the human guards working at the main gate.
19—Equipped with a system of electronic card and imprinting system for those who are eligible to have it. In addition to having a device for work card showing the entry time of the employee.
20—It counts the number of vehicles getting in through the gate along with identifying the type, number, and date.
21—The vehicle weight is determined upon entering the facility and the difference in weights upon leaving the facility after loading the consignments.
22—It programs the registered vehicles of the employees through their plate numbers to allow them automatically enter the facility to avoid any traffic jams at the main gates at the beginning if the working hours.
23—It is easy to be used by the guards.
24—This device is distinguished for being easy to be used by employees.
25—Effective in carrying out its security functions without introducing human beings to any danger whether the individual committing the violation is:
   a. Perpetrator
   b. Wandering
   c. Mentally ill
   d. Underage
   e. Drug/Alcohol Addict
26—The duty of the guards is to inspect and resist but once this device is installed, then it will become its own duties to resist, guard, and arrest in case the guard is not available under any circumstances even there are any neglicance or failure to carry out the duties by the guards. It terminates the role of human support to deter the intruders violating the rules.
27—Equipped with a bumper to force the employees to comply with the speed limits according to the traffic sign.
28—The device cannot be seen and nobody feels that there is any device at the main gate.
29—Each main gate has the freedom to select the required specifications and deselect the unnecessary features according to the work nature of the gates whether they are private or public gates.
30—The device allows the vehicles and individuals who comply with the rules to pass by the device equipment safely

1- An integrated security system that includes:
Cars bumper at the entrance gate 2.
A sensor designated to identify the metal pieces pre-loaded in the device with an identification system of the employees' cards to gain a permission to enter, as well as an imprint identification system to get a permission to enter. The three-way system operas as in 31. In addition, any similar system can be used to presumably carry out the same purpose.
A second sensor device 3, designated for vehicles and people as per demand and needs on the gate.
Weapons detector 7.
Explosives detector 8.
A direct visual imaging device with lighting for the inspection of vehicles 6 to transfer the image to the screen 28.
Vertical gate 9.
Beam device 10 placed on the two traffic signals 43, and the device order to operate according to the traffic signals with red and green lights and floor pad 11 works in parallel with the ray device 10 along with the two traffic lights.
The surface of the basement room ceiling 26 is equipped with studs 12 and spring 44 and having a track 24 where a sensor 45 is placed in its center. Inside this track there is a speed bump 25 with parts under it 36 along with a column. Also, it forces the surface to go down as a result of the effect of the vehicle pushing the bumper in a mechanical movement. This system fully absorbs the vehicle speed to stop it. It has lengths and base in the floor 35 can be replaced in any other place carrying out the same purpose. In addition, hydraulic pistons 32 installed in the surface of the device facilitate the surface up-down movement.
The room under the surface shall have sufficient depth and lengths, sides and floor 22, 23 as well as a frontal tunnel as needed 38, 37, 40, and 41.
Steel mesh cages 21 or any other material to meet the same purpose which rises up from the basement room through the pistons 33 for the detention of persons.
An emergency gate can be opened from any part of the room to remove detainees and to carry out inspections.
An alarm bell 17 vibrating 18 camera 19 confusing spotlights 20.
A sensitive device 27 of the gate specific for individuals climbing the main gate.
A wireless signal receiver 13.
Concrete bumpers 15, any means can also be used carrying out the same purpose, walls or sand bags and the like.
An automatic control device of the system 16 via the light according to the programming required.
A computer 29 and a control unit to operate the system manually through the guard using electric or hydraulics plugs also any other means can be used to carry out the same purpose.
An alarm bell 5 for workers at the gate.
cats eyes 14 and asphalting the surface with drawing the lines on it.
Device demonstrates the entry of employees and the time 30 and any device can be added along with the device system for additional new software to the existing one.
A wire cable 39 fixed on a net 4 to be raised from the rear side.
Fire extinguisher 40 with sensors and plumbing.
A place for collecting rain 41, waste, and so on.
The inside depth of the room from 42 encompassed from the sides.

2- Security gates device in accordance with claim 1 where the car bumper 2 includes and electronic weighing scale 1 that weighs the vehicle as they pass over the bumper. It shall be installed in the bottom of the bumper.

3- Gates security device in accordance with claim 1, where the sensor of the metal pieces 31 identifies the employees' vehicles via metal pieces attached to their vehicles. The sensor produces a signal to the system to open the barriers and so they pass the device components safely. Also, a special device for electronic cards and imprint can be added or any other system that carries the same purpose to gain the permission to automatically enter the gate. These issues are used at the gates where there are not any labors.

4- Gates security device in accordance with claim 1, sensor 3 to give order of operating the system for one vehicle only to avoid duplication of the entry of several vehicles in a single command, as well as people.

5- A security gates device in accordance with claim 1 where the weapon detector, explosives detector, visual inspection device and lighting 6, 7, 8 are all operating simultaneously by one movement and one course of action plan to inspect the vehicles and the like with the addition of other detectors as needed to carry out the same purpose and a device 6, 7, 8 can be installed on the surface of the room floor 22 or the ceiling 26 according to the appropriate location, which satisfy the need for that device to inspect and transfer live images on the screen 28 in the guard's room.

6- A security gates device in accordance with claim 1 where the device 6 is linked to the visual display screen 28 and to the guard's room to inspect the vehicles.

7- A security gates device in accordance with claim 1 where the weapon detector and explosives detector, 7, 8 in the case of discovery of any weapons or explosives to give an electronic signal so that all the components of the system operate to provide a comprehensive security protection as well as lifting the rear clamp barrier 4 tied to a wire cable 39 to lift the vehicle from the backside to force it go down into the fenders room surrounded by security isolators to resist the blast so as to protect the facility and employees. The location of the inspection devices to be placed inside the room floor 22 so that the inspection is carried out in the fenders room. When there is any signal that there is something, paragraphs 2, 21, 27, 17, 18, 19, 20 shall operate along with the sliding down 32 and rising up 33 of the pistons and the warning bell 5.

8- A security gates device in accordance to claim 1 which has a gate 9 to prevent vehicles from reaching the rays 10 and 11 the pad accidentally so as to take certain measures in the inspection area and the like.

9. The command is directed to the ray device 10 and the ground pad 11 and linked with the operation of the traffic light (43) which contains the green and red lights that allows the vehicle or persons to go beyond device components safely. In case the traffic light is red then the commands are directed from the two devices 10, 11 not to allow the vehicles and persons to enter and not to exceed device equipment safely. When a vehicle or persons passing the device, then it gives a command to the front studs 12 to open and the surface goes down below the room floor. A weight is used to push down the vehicle using a rubber spring to prevent the collision of the vehicle with the ceiling or the floor as well as directing a signal at the same time to the speed bump 25 rises by 36 very soon using a piston and the spring to serve as a barrier to absorb the vehicle speed instead of the a speed bump so that the vehicle hits and pushes it in the track 24 forward to absorb the speed to enable the surface to go down in mechanical movement as well as to contact the sensor 45, within the track 24 to run a full system for the protection of comprehensive security.

10- A security gates device in accordance with claim 1 where the surface 26 is equipped with studs 12 which operate by opening and closing using a piston where they receive the commands to open as in 10, 11, or by a command of the guard. the surface goes down from the front side where a weight is attached to the vehicle connected with a rubber spring 44 to avoid to be collided with the room floor as well as the ceiling is connected with a hydraulic pistons 32 to raise and lower surface supported by iron bridges and the blacksmith work and the like to open the track 24 in the middle of the same there is a sensor 45. Within this track there is a bump 25 so as the authorized vehicle complies with the pre-determined speed and has parts under the bump 36 and the base column 35 and the post of the base and a spring 34. They all operate to absorb the speed of the unauthorized vehicle as well as to force the surface to go down from the front side when the barriers is extended in the track. Also, to move or and touching the sensor 45 to operate the whole system via the sensor 45 which shall do the following:
Remove the rear studs 12 using a piston.
Give a command to the piston of the hydraulic arm 32 to force the surface 26 to go down from the back side into the room between the fenders and the isolators 22, 23.
The hydraulic arm of the piston 33 lifts up the mesh cages 21 from the room up till it surrounds the vehicle and the persons to detain them. At the STOP stage the arm is provide d with electricity.
The bumper No. 2 is lifted to prevent any intrusion supporting the first intrusion as well as to protect the back net 4 from being destroyed.
the main gate is closed where there is a sensor 27 located over the gate.
Runs the alarm bell 5 of the employees at the gate as well as the alarm system 17 installed for employees and persons in-charge inside the facility and to run the vibrator 18 and the camera 18 is turned on for full event photography to be used in the investigation. Spotlights 20, which do not work except in the case of emergency, should have a separate electricity line other than one available for the gate which works to give an unsteady lighting so as not to see what is behind the lighting.

11. A security gates device in accordance with claim 1 paragraphs 22, 23 having insulators and cement works and the like to resist and absorb the blast of the vehicle caught by the device so as to have enough thickness in all edges and sides of the basement room taking in consideration that a frontal tunnel 38 can be added within an enough space in front of the room to accommodate large vehicles and trucks with the installation of a surface for this tunnel 37 made of concrete or anything else satisfy the same purpose so as the vehicles pass over the tunnel safely. It also equipped with a fire extinguisher 40 with sensors and plumbing 41 the drainage site of rain and wastes through specific locations and others as well 21 nets inside and around the sides which rise up upon demand taking in consideration that room has a rectangular shape or otherwise satisfy the purpose knowing that the length, width and depth are according to the requirements of the gate.

12. A security gates device in accordance with claim 1 where the command is received by the alarm bell 17 the vibrator 18 the camera 19 and curly confusing lighting 20 which receives guidance from a sensor 45 when it moves by the bumper located in the track.

13. A security gates device according to claim 1 where the main gate is equipped with sensors 27 as they give a signal to the system to run in case there are individuals climbing the gate, then it gives a signal to detain the climbers through 21 and running the device numbers according to the programming which should be specified for comprehensive security protection.

14. A security gates device according to claim 1 where wireless signal receiver 13 for running all parts of the device by wireless remote control or manual control via the guard or controls buttons or any other means satisfying the same purpose.

15. A security gates device according to claim 1 where the concrete work 15 whose role is to organize the traffic by forcing the vehicles to pass over the surface of the device. Also, when a blast takes place it prevents the fragments from its direction to the sites around the device and it can be replaced by walls or sand bags or any substance can be used to satisfy the same purpose.

16. A security gates device according to claim 1 which is a device to control the system automatically through light to have a programming as needed either after the end of the working hours, at sunrise or sunset, e.g. pushing down the surface 26 and raising the fender 2 at sunrise or sunset and other programming can chosen to satisfy the same purpose according to the need of the gate.

17. A security gates device according to claim 1 which is a computer 29 controlling the system programming and fully running the system as well as issuing commands to the manual system by the guard at the gate. It can be replaced by another device satisfy the same purpose.

18. A security gates device according to claim 1 which is an alarm bell 5 for the guards at the gate to notify them that the device is operational and that the gate was exposed to unauthorized entry.

19- A security gates device according to claim 1 which is cats eyes 14 along with asphalting the surface 26 as well as drawing lines on the road so that the device is placed in a secret place to the extent that nobody sees or even know that such a device is available. A decoration can be used instead of asphalting in various forms as the purpose is to have the device in a position where it can be seen using the surface forms satisfying the purpose.

20. A security gates device according to claim 1 which is a device 30 identifying the employee's entry and the time. Also, any device can be added to the device system using the new software compared to the one exists and as needed.

21. A security gates device according to claim 1 which a wire cable 39 is having lengths attached to the net 4 and the other end is the beginning of the surface 26. As when net rises 4 using a piston 33, the wire cable 39 rises the vehicle form the backside and forcing it to go down the surface then to the room. Also, it deters and forces the vehicles that get back of the device, then it forces them to go down in a balanced way 39 on the level 26 with tunnel surface which has more depth level 26 according to in a straight line. the vehicle from the rear and forcing it to land on the surface and then room as well as to deter and force vessels undo device it forces them out in a balanced way, 39 with level 26 with tunnel floor in straightening one more depth.

22. A security gates device according to claim 1 which is fire extinguisher 50 with fire sensors and carrying out full plumbing of the room from inside and outside.

23. A security gates device according to claim 1 which is a site 41 for collecting and draining the rain water and waste and other.

24. A security gates device according to claim 1 where it is possible to open the emergency door from any location of saving and getting out the detainees inside the room, it can be used to carry out inspection to go down inside the room.
